(19) United States
(12) Patent Application Publication
(10) Pub. No.: US 2006/0099369 A1
(43) Pub. Date: May 11, 2006

(54) EVA foam sponge self-adhesive solid character

(76) Inventor: Chih-Ta Chen, Chang-Hwa Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/983,701

(22) Filed: Nov. 9, 2004

(51) Int. Cl. B32B 33/00

(52) U.S. Cl. 428/40.1

(57) ABSTRACT

An EVA foam sponge self-adhesive solid character including a character layer made of EVA foam sponge, an adhesive layer adhered to backside of the character layer and a releasable paper overlaid on the adhesive layer. The character layer can have a form of an English alphabet such as “A” or Chinese characters of a distich or good-luck slogans or an advertisement slogan. After a user tears off the releasable paper, via the adhesive layer, the character layer can be firmly adhered to a stationary article such as a wall or a door. Accordingly, the distich, good-luck slogans, advertisement sign, etc. can present solid characters.

### BACKGROUND OF THE INVENTION

1. Field of the Invention

The present invention is related to a self-adhesive solid character, and more particularly to a self-adhesive solid character made of ethylene-vinyl acetate (EVA) foam sponge.

2. Description of the Prior Art

In a holiday such as Christmas or a party, papers with slogans of celebrating or blessing words or characters are often attached to the door or wall. In Chinese traditional festivals such as Chinese New Year, Chinese' often attach distiches, good-luck slogans on the door or wall to express blessing and joy. The characters or words of such distiches and good-luck slogans are generally printed or written on papers by brush pens. Accordingly, the characters or words have a plane form.

The existent solid characters are generally made of wooden material by sculpture. After sculptured, the wooden solid characters are painted with an adhesive and then adhered to a stationary article or nailed on a stationary article. Such solid wooden characters are manually sculptured so that the manufacturing cost is quite high and the manufacturing procedure is quite time-consuming. Therefore, it is impossible to mass-produce such solid wooden characters.

### SUMMARY OF THE INVENTION

It is therefore a primary object of the present invention to provide an EVA foam sponge self-adhesive solid character including: a character layer made of EVA foam sponge; an adhesive layer adhered to backside of the character layer; and a releasable paper overlaid on the adhesive layer. The character layer can have a form of an English alphabet such as “A” or Chinese characters of a distich or good-luck slogans or an advertisement slogan. After a user tears off the releasable paper, via the adhesive layer, the character layer can be firmly adhered to a stationary article such as a wall or a door. Accordingly, the distich, good-luck slogans, advertisement sign, etc. can present solid characters.

The EVA foam sponge self-adhesive solid character of the present invention has the following advantages:

1. The adhesive layer is fully disposed over the backside of the character layer so that the character layer can be firmly adhered to a stationary article.

2. A user only needs to tear off the releasable paper and then adhere the character layer onto the article without additionally painting paste on the character layer. Therefore, it is quite convenient to use the present invention.

3. The character layer made of the EVA foam sponge has a certain thickness. Therefore, the character is presented in a solid form better than the plane character written by a brush pen.

4. The EVA foam sponge material can be punched by oil press to form the characters. Therefore, the EVA foam sponge self-adhesive solid character of the present invention can be fast mass-produced.

The present invention can be best understood through the following description and accompanying drawings wherein:

### BRIEF DESCRIPTION OF THE DRAWINGS

FIG. 1 is a perspective view of the present invention;

FIG. 2 is a sectional view taken along line 2-2 of FIG. 1;

FIG. 3 shows that the releasable paper of the present invention is torn off; and

FIG. 4 is a plane view of the present invention.

### DETAILED DESCRIPTION OF THE PREFERRED EMBODIMENTS

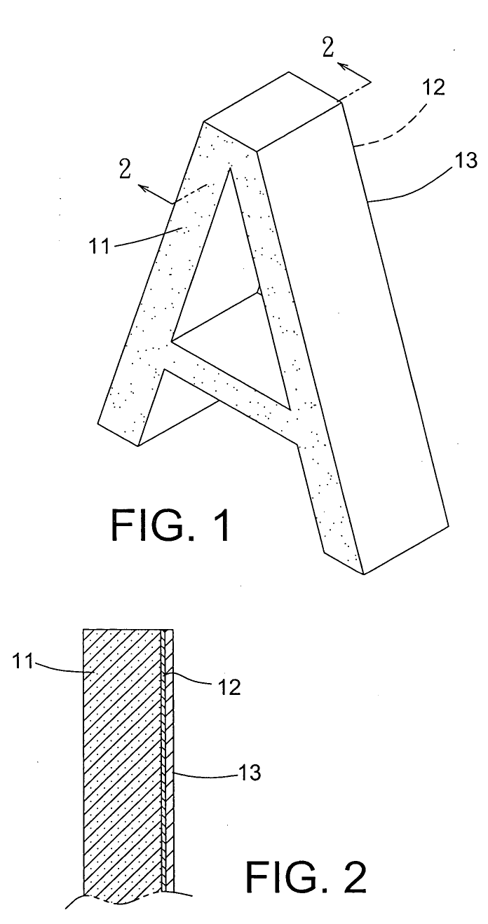

Please refer to FIGS. 1, 2 and 3. The EVA foam sponge self-adhesive solid character of the present invention includes a character layer 11 made of EVA foam sponge, an adhesive layer 12 adhered to backside of the character layer 11 and a releasable paper 13 overlaid on the adhesive layer 12. The character layer 11 can present one single alphabet such as “A” or a word or an advertisement slogan or a blessing phrase. After a user tears off the releasable paper 13, via the adhesive layer 12, the character layer 11 can be firmly adhered to a stationary article such as a wall or a door. Accordingly, a distich, good-luck slogans, an advertisement sign, etc. can present solid characters.

In manufacturing of the EVA foam sponge self-adhesive solid character of the present invention, a whole piece of EVA foam sponge is prepared. The adhesive layer 12 is adhered to one face of the EVA foam sponge. The releasable paper 13 is overlaid on the adhesive layer 12. Then the EVA foam sponge is punched by an oil press to form the character. Alternatively, the EVA foam sponge can be cut or scissored to form the character.

The adhesive layer 12 can be fully disposed over the backside of the character layer 11. Alternatively, the adhesive layer 12 can be partially disposed on the backside of the character layer 11.

The pattern of the character layer 11 can be an English alphabet such as “A” of FIG. 1 or any other word such as “Merry X'mas” or any other advertisement slogan. This is not limited.

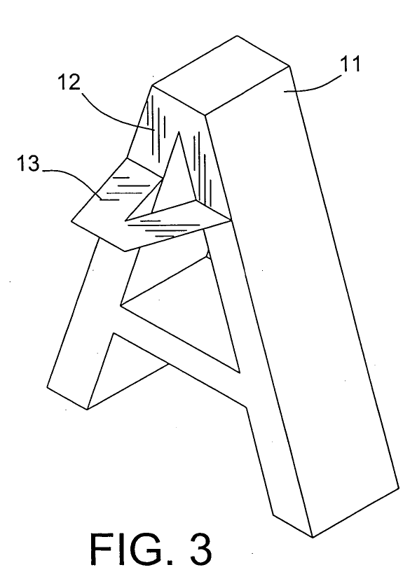

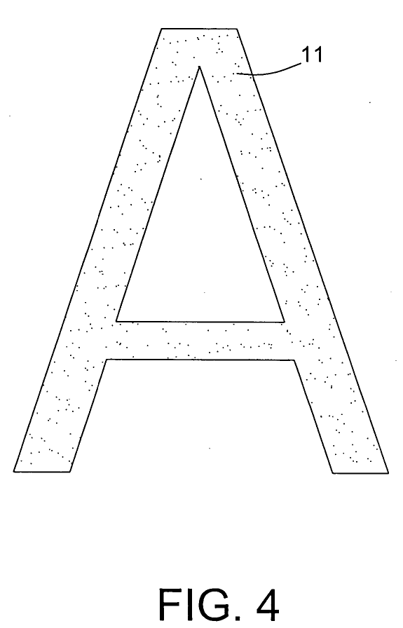

In use of the present invention, as shown in FIGS. 3 and 4, the releasable paper 13 is torn off from the backside of the EVA foam sponge. Then, via the adhesive layer 12 on the backside of the character layer 11, the character layer 11 can be firmly adhered to a door or a wall without easy detachment.

The EVA foam sponge self-adhesive solid character of the present invention has the following advantages:

1. The adhesive layer 12 is fully disposed over the backside of the character layer 11 so that the character layer 11 can be firmly adhered to a stationary article.

2. A user only needs to tear off the releasable paper 13 and then adhere the character layer 11 onto the article without additionally painting paste on the character layer 11. Therefore, it is quite convenient to use the present invention.

3. The character layer 11 made of the EVA foam sponge has a certain thickness. Therefore, the character is presented in a solid form better than the plane character written by a brush pen.

4. The EVA foam sponge material can be punched by oil press to form the characters. Therefore, the EVA foam sponge self-adhesive solid character of the present invention can be fast mass-produced.

The above embodiments are only used to illustrate the present invention, not intended to limit the scope thereof. Many modifications of the above embodiments can be made without departing from the spirit of the present invention.

What is claimed is:

1. An EVA foam sponge self-adhesive solid character comprising:
a character layer made of EVA foam sponge and having a form of a character;
an adhesive layer adhered to backside of the character layer; and
a releasable paper overlaid on the adhesive layer, whereby after a user tears off the releasable paper, via the adhesive layer, the character layer can be firmly adhered to a stationary article.
